(19) United States
(12) Patent Application Publication
(10) Pub. No.: US 2021/0355034 A1
(43) Pub. Date: Nov. 18, 2021

(54) THERMAL BARRIER COATING AND ARTICLE COMPRISING SAME

(71) Applicant: The University of Connecticut, Farmington, CT (US)

(72) Inventors: Maurice Gell, Somerset, NJ (US); Eric Jordan, Storrs, CT (US); Jeffrey Roth, Bolton, CT (US)

(21) Appl. No.: 16/163,475

(22) Filed: Oct. 17, 2018

Related U.S. Application Data
(63) Continuation of application No. 14/614,665, filed on Feb. 5, 2015, now abandoned.
Application No. 14/614,665 is a continuation of application No. 14/386,492, filed on Sep. 19, 2014, now abandoned.
(60) Provisional application No. 61/636,755, filed on Apr. 23, 2012.
(60) Provisional application No. 61/708,226, filed on Oct. 1, 2012.

(51) Int. Cl. C04B 35/44; C23C 4/02; C23C 28/00; C23C 4/11; C23C 4/134; C23C 4/10; F01D 5/28; F02C 7/24

(52) U.S. Cl. CPC C04B 35/44; C23C 4/02; C23C 28/3215; C23C 28/3455; C23C 28/36; C23C 4/11; F05D 2300/2112; C23C 4/10; F01D 5/288; F02C 7/24; Y10T 428/24997; Y10T 428/24471; Y02T 50/60; C23C 4/134

(57) ABSTRACT

A method for manufacturing a coating includes dissolving at least one salt in a mixture of water and ethanol to form a precursor solution, adding an additive to the precursor solution to form a fuel solution, and injecting the fuel solution into a plasma flame. The additive includes at least one of urea or ammonium acetate. The additive functions as a fuel to increase a temperature of the plasma flame. The method further includes manufacturing the coating on a substrate. The coating includes a garnet structure including a predetermined amount of yttrium-aluminum, one or more first cracks extending completely through a thickness of the coating, and a porosity greater than ten volume percent.

### CROSS-REFERENCE TO RELATED APPLICATIONS

This application is a continuation application of U.S. patent application Ser. No. 14/614,665, filed Feb. 5, 2015, which is a continuation application of U.S. patent application Ser. No. 14/386,492, filed Sep. 19, 2014, which is a national stage application of PCT/US2013/037525, filed Apr. 22, 2013, which claims the benefit of U.S. Provisional Patent Application No. 61/636,755, filed Apr. 23, 2012, and U.S. Provisional Patent Application No. 61/708,226, filed Apr. 23, 2012. Each of these applications is incorporated by reference herein in its entirety.

### BACKGROUND OF THE INVENTION

The thermodynamic efficiency of gas turbines can be improved significantly by maximizing inlet temperature and/or reducing the volume of air required for cooling airfoils. The most promising approach to achieve higher operating temperatures while protecting the superalloy substrates from degradation and failure is the use of thermal barrier coatings. Yttria-stabilized zirconia with about 7 mole percent yttria (7YSZ) has been recognized as a preferred material for thermal barrier coatings due to a combination of outstanding materials properties such as thermodynamic stability in the operating environment up to 1200° C., very low thermal conductivity, relatively high thermal expansion coefficient, and the ability to be processed with relatively high strain-tolerance through coating techniques such as air plasma spray (APS) and electron-beam physical vapor deposition (EB-PVD). See, e.g., M. Gell, E. H. Jordan, M. Teicholz, B. M. Cetegen, N. P. Padture, L. Xie, D. Chen, X. Ma, and J. Roth, “Thermal Barrier Coatings Made by the Solution Precursor Plasma Spray Process,” Journal of Thermal Spray Technology, volume 17, no. 1, pages 124-135 (2008). The practical use of 7YSZ-based thermal barrier coatings is limited to a maximum operating temperature of approximately 1200° C. due to its phase instability above 1200° C. APS-processed 7YSZ consists of predominantly metastable t′ phase at room temperature. Upon high-temperature exposure above 1200° C. for extended periods of time, the t′ phase separates into yttrium-deficient tetragonal (t) and yttrium-rich cubic (c) fluorite phases. Upon cooling, the tetragonal phase undergoes martensitic transformation to a monoclinic phase, with a volume expansion of about four to five percent that has a detrimental effect on the thermal barrier coating quality leading to spallation and failure. See V. Luigi and D. R. Clark, “High temperature aging of YSZ coatings and subsequent transformation at low temperature,” Surface & Coatings Technology, volume 200, no. 5-6, pages 1287-1291 (2005).

New materials that can meet the performance standards of 7YSZ but can extend the operating window to higher temperatures, for example to 1300° C. or above, can facilitate the development of turbines that can operate at elevated temperature. A variety of materials have been proposed and evaluated as higher temperature thermal barrier coatings candidates, but none has yet emerged as a clear winner due to the difficulty in meeting the combination of factors required to be a viable high-temperature thermal barrier coating material. See Z. O. Cao, R. Vassen, and D. Sroever, “Ceramic material for thermal barrier coatings,” Journal of European Ceramic Society, volume 24, pages 1-10 (2004); D. Stover, G. Pracht, H. Lehmann, M. Dietrich, J-E Dorning, and R. Vassen, “New material concepts for the next generation of plasma sprayed thermal barrier coatings,” Journal of Thermal Spray Technology, volume 13, no. 1, pages 76-83 (2004); and R. Vassen, A. Stuke and D. Stover, “Recent Developments in the Field of Thermal Barrier Coatings,” Journal of Thermal Spray Technology, volume 18, no. 2, pages 181-186 (2009). In addition to meeting the primary requirement of a thermal conductivity less than that of 7YSZ, any candidate thermal barrier coating system must in addition possess the properties of resistance to fuel-based contaminants, adequate erosion resistance, higher temperature phase stability to avoid generally catastrophic volume changes associated with phase change, and compatibility with the thermally grown oxide (TGO) which forms on the substrate. An extensive literature exists on alternate composition thermal barrier coatings. See, e.g., C. G. Levi, “Emerging materials and processes for thermal barrier systems,” Current Opinion in Solid State and Materials Science, volume 8, pages 77-91 (2004); and D. R. Clarke and S. R. Phillpot, “Thermal barrier coating materials,” Materials Today, June 2005, pages 22-29. The most commonly studied systems include (1) doped zirconia-based systems with dopants that can prevent the detrimental phase transformations, (2) zirconates, (3) fluorites, and (4) two-layer structures containing a YSZ inner layer (in contact with the substrate) and a zirconate or fluorite outer layer. A key conclusion from a review of this literature is that most of the seriously considered alternative systems have some, but not all, properties superior to the baseline YSZ. For example, phase stability studies have indicated that all the pyrochlore zirconates are prone to degrade the TGO by interdiffusion, requiring incorporation of a compatible “diffusion barrier”, typically 7YSZ, for safe implementation. Zirconates have also shown limited stability under burner rig conditions. Additional issues arise when considering environmental effects on alternative thermal barrier coating materials. It has also been reported that alternate thermal barrier coating compositions generally exhibit lower erosion resistance than 7YSZ. For example, the following erosion rates relative to 7YSZ (rate=1) were measured in EB-PVD coatings: 20YSZ (129), CeO2 (35), 12YCeO2 (22), and 12YSZ (2.3). See M. J. Maloney, H. S. Achter, and R. H. Barkalow, “Development of ceria-based low thermal conductivity thermal barrier coatings,” Proceedings of the 1997 Thermal Barrier Coating Workshop (1997). Several multilayer thermal barrier coating systems have also been proposed, but these systems face challenges associated with higher processing costs and complexity unless simple, highly durable, and reliable systems can be processed in a relatively fast and effective manner.

Thus, there remains a need for thermal barrier coatings that are thermally stable above 1200° C. without substantially compromising other beneficial attributes of 7YSZ coatings.

### BRIEF SUMMARY OF EMBODIMENTS OF THE INVENTION

Embodiments of a method are disclosed. In some embodiments, a method for manufacturing a coating includes dissolving at least one salt in a mixture of water and ethanol to form a precursor solution, adding an additive to the precursor solution to form a fuel solution, and injecting the fuel solution into a plasma flame. The additive includes at least one of urea or ammonium acetate. The additive functions as a fuel to increase a temperature of the plasma flame. The method further includes manufacturing the coating on a substrate. The coating includes a garnet structure including a predetermined amount of yttrium-aluminum, one or more first cracks extending completely through a thickness of the coating, and a porosity greater than ten volume percent. Other embodiments are disclosed herein.

In some embodiments, the manufactured coating further comprises a plurality of first cracks extending completely through the thickness of the coating, wherein the plurality of first cracks are spaced apart a distance that is less than or equal to half the thickness of the coating.

In some embodiments, the garnet structure comprises (C) sites, (A) sites, and (D) sites. In some embodiments, the (C) sites are occupied by a trivalent metal ion or a mixture of trivalent metal ions selected from the group consisting of: yttrium ions, scandium ions, lutetium ions, lanthanum ions, cerium ions, praseodymium ions, neodymium ions, promethium ions, samarium ions, europium ions, gadolinium ions, terbium ions, dysprosium ions, holmium ions, erbium ions, thulium ions, ytterbium ions. In some embodiments, the (A) sites and the (D) sites are independently occupied by a trivalent metal ion or a mixture of trivalent metal ions selected from the group consisting of: aluminum ions, gallium ions, iron ions, chromium ions, and scandium ions. In some embodiments, the (C) sites are occupied by yttrium ions. In some embodiments, the (A) sites and the (D) sites are independently occupied by a metal ion or a mixture of metal ions selected from the group consisting of: aluminum ions, iron ions, gallium ions, and scandium ions. In some embodiments, the (C) sites are occupied by a metal ion or a mixture of metal ions selected from the group consisting of: yttrium ions, cerium atoms, neodymium atoms, terbium atoms, ytterbium atoms. In some embodiments, the (A) sites and the (D) sites are occupied by aluminum ions.

In some embodiments, the garnet structure comprises a yttrium-aluminum garnet (Y₃Al₅O₁₂). In some embodiments, the coating further comprises one or more second cracks extending partially through the coating. In some embodiments, the one or more second cracks extend at least half of the thickness of the coating. In some embodiments, a first crack changes direction in extending completely through the coating. In some embodiments, a plurality of first cracks change direction in extending completely through the coating. In some embodiments, a first crack changes direction and changes width in extending completely through the coating. In some embodiments, a plurality of first cracks change direction and change width in extending completely through the coating. In some embodiments, a first crack changes width in extending completely through the coating. In some embodiments, a plurality of first cracks change width in extending completely through the coating.

In some embodiments, the coating further comprises a plurality of yttrium-aluminum columns. In some embodiments, the plurality of yttrium-aluminum columns are mechanically separated by the one or more first cracks. In some embodiments, the coating further comprises inter-pass boundaries and splats including an average diameter that is less than or equal to 5 micrometers. In some embodiments, the coating comprises a thermal barrier coating, and the thermal barrier coating includes a porosity in the range of ten volume percent to forty volume percent. In some embodiments, the one or more first cracks each include a width in the range of 0.1 micrometers to 5.0 micrometers and the thickness of the thermal barrier coating is in the range of 50 micrometers to 5,000 micrometers. In some embodiments, the coating comprises a thermal barrier coating. These and other embodiments are described in detail below.

### BRIEF DESCRIPTION OF THE DRAWINGS

FIG. 1 is a schematic illustration of a solution precursor plasma spray (SPPS) process.

FIG. 2 is a schematic illustration of the crystal structure of garnets, showing “A”, “C”, and “D” sites occupied by metal ions (oxygen atoms are not shown).

FIG. 3 is a scanning electron micrograph of a section of an yttrium aluminum garnet (YAG) coating exhibiting a “feathery” microstructure.

FIG. 4 is a scanning electron micrograph of a section of an SPPS YAG coating exhibiting inter-pass boundaries and vertical cracks.

FIG. 5 is a set of scanning electron micrographs of sections of SPPS YAG coatings from Example 2 and illustrating the effects of standoff distance and index; the corresponding sample numbers appear in each micrograph, and the conditions for their formation are summarized in Table 2; in the first and second rows, the left micrograph is for a cross-section of the coating, the center micrograph is a magnified cross section of another coating sprayed at the same time, and the right micrograph is a magnified cross section of a third coating sprayed at the same time.

FIG. 6 is a set of scanning electron micrographs of sections of SPPS YAG coatings from Example 2 and illustrating the effect of differences in standoff distance; the corresponding sample numbers appear in each micrograph, and the conditions for their formation are summarized in Table 3.

FIG. 7 is a set of scanning electron micrographs of sections of SPPS YAG coatings from Example 2 and varying in the presence or absence of ammonium acetate or urea in the precursor composition; the corresponding sample numbers appear in each micrograph, and the conditions for their formation are summarized in Table 4.

FIG. 8 is an x-ray diffraction pattern of sample 050812-A from Table 4.

FIG. 9 is a scanning electron micrograph of the Table 2 sample 041112-A structure after heat treatment at 1100° C. for one hour.

FIG. 10 is a set of electron micrographs illustrating the effect of radial distance on coating morphology; the upper images correspond to two enlargements of a cross-section of a coating prepared with a 7 5 millimeter radial distance; the lower images correspond to a cross section at two enlargements of a coating prepared with a 5 5 millimeter radial distance.

FIG. 11 is a set of electron micrographs illustrating the effect of standoff distance on coating morphology; the upper images correspond to two enlargements of a cross-section of a coating prepared with a 1.25 inch standoff distance; the middle images correspond to two enlargements of a cross section of a coating prepared with a 1.375 inch standoff distance; the lower images correspond to two enlargements of a cross section of a coating prepared with a 1.5 inch standoff distance.

FIG. 12 is a set of electron micrographs illustrating the effect of solvent composition on coating morphology; the upper images correspond to two enlargements of a cross-section of a coating prepared with a solvent containing 25% water and 75% ethanol; the middle images correspond to two enlargements of a cross section of a coating prepared with a solvent containing 50% water and 50% ethanol; the lower images correspond to two enlargements of a cross section of a coating prepared with a solvent containing 75% water and 25% ethanol.

FIG. 13 is a set of electron micrographs illustrating the effect of urea addition to the precursor solution; the upper images correspond to two enlargements of a cross-section of a coating prepared with no urea added to the precursor solution; the middle images correspond to two enlargements of a cross section of a coating prepared with 5 weight percent urea in the precursor solution; the lower images correspond to two enlargements of a cross section of a coating prepared with 10 weight percent urea in the precursor solution.

FIG. 14 is a set of electron micrographs illustrating two SPPS coatings; the upper images correspond to two enlargements of a cross-section of a “dense” coating; and the lower images correspond to two enlargements of a cross-section of a “feathery” coating; preparation of both coatings is described in Example 4.

FIG. 15 is a schematic illustration of a thermal cycling test conducted at the University of Connecticut (UConn).

FIG. 16 is a plot of results from the thermal cycling test conducted at UConn.

FIG. 17 is a pair of electron micrographs for the dense coating after 217 hours (before failure; left), and after 636 hours (after failure; right) in the UConn thermal cycling test.

FIG. 18 is a temperature profile for a thermal cycling test conducted at HiFunda; the red line is for the sample holder temperature, and the blue line is for the furnace temperature.

FIG. 19 consists of photographic images of SPPS YAG, SPPS YSZ, and APS YSZ coated coupons before and after 270 hours of thermal cycling in the HiFunda test.

FIG. 20 consists of two photographic images and a schematic diagram of the HiFunda thermal conductivity apparatus.

FIG. 21 consists of two plots—SPPS YSZ on the left and SPPS YAG on the right—of effective thermal conductivity versus temperature as measured on the HiFunda thermal conductivity apparatus.

FIG. 22 is a set of electron micrographs illustrating the “dense” SPPS YAG coating before and after cycling, with the “before” images magnified 500 times and the “after” images magnified 1000 times. In each row, the left image is a scanning electron micrograph, and the right image is a digital enhancement of the left image emphasizing porosity and vertical cracks.

### DETAILED DESCRIPTION OF THE INVENTION

The present invention generally relates to the use of solution precursor plasma spray to form thermal barrier coatings comprising YAG-based ceramics. YAG itself has proven stability at elevated temperatures and excellent high-temperature mechanical properties. To date, the limitation in the use of YAG-based ceramics as thermal barrier coatings has been related to the difficulty in processing them with a sufficiently compliant microstructure to achieve the required strain tolerance. The present method solves that problem by utilizing a solution precursor plasma spray process (SPPS) to generate thermal barrier coatings with compliant microstructure and adequate strain tolerance. The thermal barrier coatings comprising YAG-based ceramics exhibit markedly improved high temperature properties relative to 7YSZ.

Polycrystalline garnet ceramics are used in a variety of high-temperature applications due to their unique properties. In particular, YAG (Y₃Al₅O₁₂) is an excellent choice due to its robust high temperature properties and phase stability up to its melting point (1970° C.). Table 1 compares the properties of YAG with those of YSZ. YAG thermal barrier coatings have much higher use temperature and erosion resistance, and lower thermal conductivity and density compared to air plasma spray (APS) YSZ thermal barrier coatings. Some of the improved properties for YAG thermal barrier coatings are enabled by use of the Solution Precursor Plasma Spray (SPPS) process that provides a highly strain-tolerant microstructure and a microstructure for which microporosity can be varied over wide ranges.

TABLE 1

| | YSZ | YAG |
|---|---|---|
| Melting Point (° C.) | 2680 | 1950 |
| Maximum Operating | 1350 | 1800 |
| Temperature (° C.) | | |
| Thermal Conductivity | 2.0-3.0 (measured) | 2.5 (extrapolated)* |
| at 1350° C. (W/m-K) | | |
| Thermal Expansion | 9.5 × 10⁻⁶ | 7.5 × 10⁻⁶ |
| Coefficient (ppm/K) | | |
| Density (g/cc at 23° C.) | 6.10 | 4.55 |
| Vickers Hardness at 23° C. | 1200 | 1700** |
| Fracture Toughness | 3 | ~1.8, but with a |
| at 23° C. (MPa · m^{0.5}) | | modest maximum |
| | | of ~2.2 at 1000° C. |

*N. P. Padture and P. G. Klemens, “Low Thermal Conductivity in Garnets”, Journal of the American Ceramics Society, volume 80, no. 4, pages 1018-20 (1997).
**D. B. Sirdeshmukh et al., “Systematic hardness measurements on some rare earth garnet crystals,” Bulletin of Materials Science, volume 24, no. 5, pages 469-473 (2001).

Use Temperature. Although YAG has a lower melting temperature than YSZ (Table 1), the maximum use temperature for a thermal barrier coating is governed by the maximum temperature that the ceramic can withstand without undergoing a phase change. YAG is phase stable up to its melting point of 1970° C. (J. S. Abell, I. R. Harris, B. Cockayne, and B. Lent, “An Investigation of phase stability in the Y₂O₃-Al₂O₃ system,” Journal of Materials Science, volume 9, pages 527-537 (1974)), whereas YSZ exhibits a tetragonal to monoclinic transformation when cooled from temperatures above 1200° C. Thus, YAG has a maximum use temperature that is over 700° C. higher than YSZ based on this criterion.

Density. YAG has a very low density of 4.55 gram per cubic centimeter at 23° C., which represents a 25% reduction compared to YSZ. The density advantage means that at a standard thermal barrier coating thickness, YAG would exert less pull (stress) on the blade root or, for the same blade pull, thicker YAG thermal barrier coatings could be used for greater thermal insulation.

Hardness. YAG has a much higher hardness than YSZ: 1700 versus 1200 for Vickers Hardness. The higher hardness can be used for improved thermal barrier coating erosion resistance or can be traded off for a higher porosity content and reduced thermal conductivity.

Thermal Conductivity. Based on the thermal conductivity measurements of Padture and Klemens, YAG has equal to or slightly higher thermal conductivity than YSZ at 1,000° C. YSZ has almost a constant value of thermal conductivity with temperature; whereas, YAG's thermal conductivity continually decreases with temperature. Extrapolation of the YAG thermal conductivity data from the 1000° C. to 1350° C. (a generous estimate of the maximum use temperature for YSZ), indicates YAG would have lower thermal conductivity than YSZ at 1350° C. It would be desirable to achieve a YAG thermal conductivity of 0.5 Watts·meter⁻¹·Kelvin⁻¹ by introducing increased microporosity, while still retaining a YAG hardness greater than YSZ for improved erosion resistance.

It is also important to consider that at elevated temperatures, heat transfer is controlled not only by conduction but also by radiation. The measured thermal conductivities of both stabilized zirconia and various zirconates are found to increase with temperatures above 1200° C. due to these ceramics being virtually transparent to radiation in the near infrared range. See, P. C. Patnaik, X. Huang, and J. Singh, “State of the Art and Future Trends in the Development of Thermal Barrier Coating Systems,” Innovative Missile Systems (pages 38-1 to 38-20), Meeting Proceedings RTO-MP-AVT-135, Paper 38. Neuilly-sur-Seine, France (2006). This radiation effect has been shown to increase the substrate temperature by as much as 50° C. (R. Siegel and C. M. Spuckler, “Analysis of Thermal Radiation Effects on Temperatures in Turbine Engine Thermal Barrier Coatings”, Materials Science and Engineering, volume A245, pages 150-159 (1998)), even at present turbine operating conditions, and it is expected to have an even greater effect at higher operating temperatures. Therefore, any coating designed to operate at elevated temperatures above 1200° C. must consider overall heat transfer through the thermal barrier coatings, including via radiation effects.

Thermal Expansion. One of the reasons for the long-term success of YSZ thermal barrier coatings is that they possess a thermal expansion coefficient that is the highest known for oxide ceramics. This high thermal expansion coefficient minimizes the thermal expansion mismatch between the ceramic and the underlying metal. In turn, the bond line stress is reduced and the spallation life increased. A number of advanced thermal barrier coating materials with lower thermal conductivities and higher use temperatures, but with lower thermal expansion coefficients, exhibited poorer thermal cyclic durability compared to YSZ and were eliminated from further consideration. See, X. Q. Cao, R. Vassen, F. Tietz, and D. Stoever, “New double-ceramic layer thermal barrier coating based on zirconia-rare earth composite oxides,” Journal of the European Ceramics Society, volume 26, pages 247-251 (2006). As indicated in Table 1, YAG also has a lower thermal expansion coefficient compared to YSZ. This limitation can be overcome by the use of the Solution Precursor Plasma Spray (SPPS) that provides a thermal barrier coating with a high density of through-coating-thickness (vertical) cracks that produces a highly strain-tolerant microstructure. The strain-tolerant microstructure of SPPS YSZ thermal barrier coatings is so strong a feature that thermal barrier coatings as thick as 4 millimeters have been made and thermally cycled with excellent durability. M. Gell, E. H. Jordan, M. Teicholz, B. M. Cetegen, N. P. Padture, L. Xie, D. Chen, X. Ma, and J. Roth, “Thermal Barrier Coatings Made by the Solution Precursor Plasma Spray Process,” Journal of Thermal Spray Technology, volume 17, no. 1, pages 124-135 (2008). The SPPS method of the present invention provides a superior high temperature/low thermal conductivity YAG thermal barrier coating, with a lower thermal expansion coefficient and superior durability compared to YSZ because of the strain-tolerant microstructure enabled by SPPS.

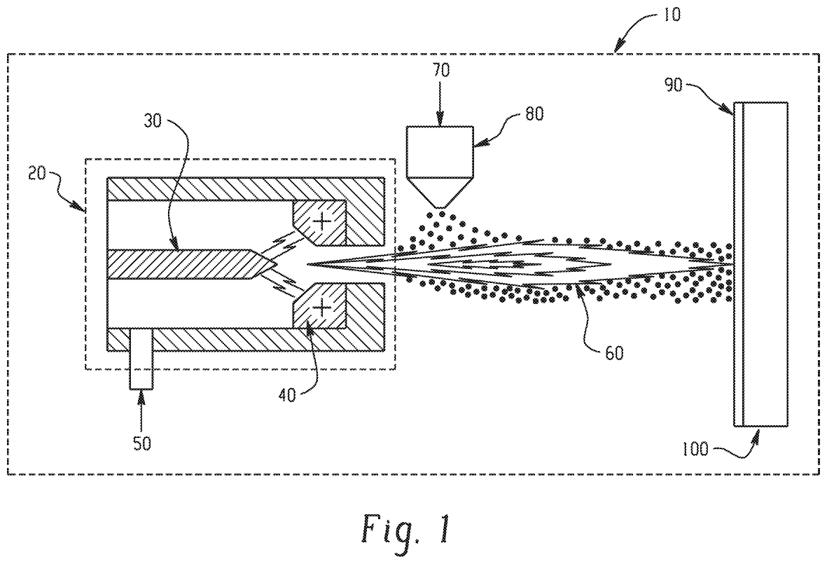

The Solution Precursor Plasma Spray (SPPS) Process. FIG. 1 is a schematic illustration of a solution precursor plasma spray system 10 comprising a plasma discharge unit 20 with tungsten cathode 30 and tungsten anode 40; a plasma precursor gas 50 is introduced into the plasma discharge unit 20, and a thermal jet 60 exits; a precursor solution 70 is introduced as a mist to the thermal jet via atomizing nozzle 80 (in other embodiments, the precursor solution is introduced to the thermal jet as a solution stream); the thermal jet 60 produces a coating 90 on substrate 100. Within the thermal jet, the injected solution droplets are fragmented (in other embodiments, the injected solution droplets are not fragmented). Also in the thermal jet, solvent is vaporized from the precursor solution droplets, at least some of the resulting salt particles are pyrolyzed to yield YAG-based ceramic particles, and the YAG-based ceramic particles are deposited on the substrate. In some embodiments, a portion of the YAG-based ceramic particles are melted and deposited on the substrate as micron-sized splats. In some embodiments, at least some of the salt particles are not pyrolyzed or incompletely pyrolyzed before being deposited on the substrate, and they are completely pyrolyzed after being deposited on the substrate. Although not shown in FIG. 1, the system can utilize more than one precursor solution and a mixer to apportion the different precursor solutions to the atomizing nozzle. In addition, multiple atomizing nozzles can be used to deposit layered compositions or provide graded coatings.

The SPPS process has been used to fabricate YAG coatings with a small amount of Dysprosium (Dy) (e.g., 1 mole percent relative to the total moles of yttrium and dysprosium) of for use as an in-situ temperature sensor. A strain-tolerant microstructure was obtained, similar to that obtained with SPPS-coated YSZ. These YAG:Dy coatings have been exposed to very high temperatures (1360° C.) at NASA-Lewis and exhibit excellent durability. The NASA-Lewis method is described in J. T. Eldridge, T. O. Jenkins, S. W. Allison, G. S. Curzen, J. J. Condevaux, J. R. Senk, and A. D. Paul “Real time thermographic phosphor-based temperature Measurement of thermal barrier coatings surfaces subject to a High velocity combustor burner environment,” Proceedings of the 57th International Instrumentation Symposium, 208 (2011).

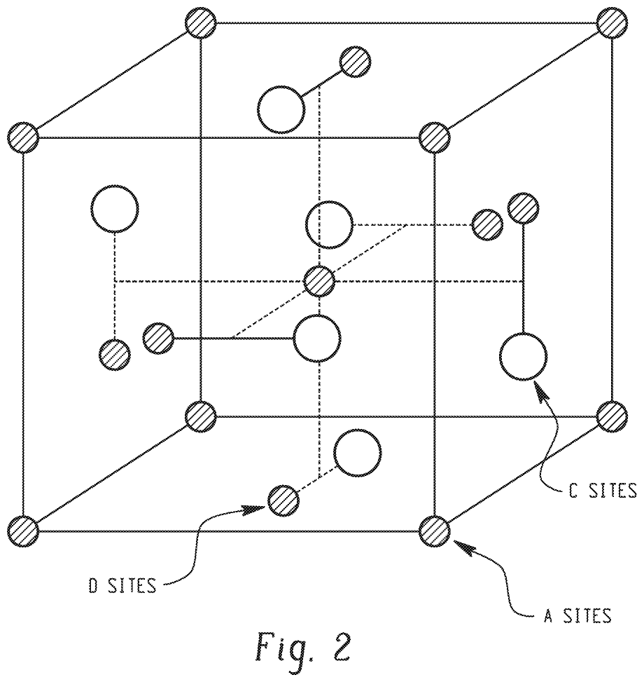

The present method is directed to the formation of thermal barrier coatings comprising a YAG-based ceramic. Yttrium aluminum garnet (YAG) has the chemical formula Y₃Al₅O₁₂. YAG belongs to the isostructural garnet family of ceramics having the garnet structure illustrated in FIG. 2, where metal sites labeled “C”, “A”, and “D” are shown, and oxygen sites are omitted for clarity. In YAG, yttrium ions occupy the “C” sites, two-fifths of the aluminum ions occupy the “A” sites, and three-fifths of the aluminum ions occupy the “D” sites. “A” sites are octahedrally coordinated with respect to oxygen, “C” sites are tetrahedrally coordinated with respect to oxygen, and “D” sites are dodecahedrally coordinated with respect to oxygen. As used herein, the term YAG-based ceramics includes ceramics having the FIG. 2 garnet structure in which “C” cites are occupied by one or more types of trivalent metal ions such as yttrium ions, scandium ions, lutetium ions, lanthanum ions, cerium ions, praseodymium ions, neodymium ions, promethium ions, samarium ions, europium ions, gadolinium ions, terbium ions, dysprosium ions, holmium ions, erbium ions, thulium ions, ytterbium ions, and the like; and “A” and “D” sites are occupied by one or more types of trivalent metal ions such as aluminum ions, gallium ions, iron ions, chromium ions, scandium ions, or the like.

In some embodiments, the YAG-based ceramic comprises YAG or a garnet structure in which part or all of the aluminum ions in the “A” and/or “D” sites of YAG are substituted with one or a mixture of iron ions, gallium ions, chromium ions, scandium ions, or the like.

In some embodiments, the YAG-based ceramic comprises YAG (Y₃Al₅O₁₂).

In some embodiments, the YAG-based ceramic comprises a garnet in which part or all of the “C” site yttrium ions of YAG are substituted with one or a mixture of scandium ions, lutetium ions, lanthanum ions, cerium ions, praseodymium ions, neodymium ions, promethium ions, samarium ions, europium ions, gadolinium ions, terbium ions, dysprosium ions, holmium ions, erbium ions, thulium ions, ytterbium ions, or the like.

In some embodiments, the YAG-based ceramic thermal barrier coating exhibits at least one of a thermal conductivity less than or equal to about 3 Watt·meter⁻¹·K⁻¹ at about 1000° C., an oxygen diffusivity less than or equal to about 10⁻¹⁵ meter²·second⁻¹ at about 1000° C., a thermal coefficient of expansion greater than or equal to about 9×10⁻⁶° C.⁻¹, a maximum temperature capability greater than or equal to about 1400° C., a hardness greater than or equal to about 14 gigapascals, an elastic modulus less than or equal to about 280 gigapascals, and a density less than or equal to about 6.4 grams·centimeter⁻³.

One embodiment is a method of forming a thermal barrier coating, comprising: injecting a precursor solution into a thermal jet, wherein the precursor solution comprises metal ion precursors to a YAG-based ceramic; evaporating solvent from the precursor solution in the thermal jet to form unpyrolyzed solid particles; pyrolyzing at least a portion of the unpyrolyzed solid particles in the thermal jet to form pyrolyzed solid particles comprising a YAG-based ceramic; melting at least a portion of the pyrolyzed solid particles in the thermal jet to form droplets comprising the YAG-based ceramic; and depositing the droplets comprising the YAG-based ceramic on a substrate to form a thermal barrier coating.

The method utilizes a thermal jet that is hot enough to melt the YAG-based ceramic. Suitable thermal jet coating techniques include suspension plasma spray coating, air plasma spray coating, vacuum plasma spray coating, ultra-high vacuum plasma spray coating, detonation spray coating, high velocity oxy fuel spray coating, atmospheric fuel spray coating, and combinations thereof. These techniques are known and need not be described in detail here.

The method includes injecting a precursor solution into a thermal jet. This can be accomplished by injecting a stream of precursor solution into the thermal jet, where it is broken into droplets. Alternatively, the precursor solution can be delivered to a liquid injector, preferably an atomizing injector nozzle or a piezoelectric crystal induced liquid injector. In some embodiments, the precursor solution is atomized in the atomizing injector nozzle into droplets up to hundreds of micrometers in size, specifically 15 to 40 micrometers, and injected into the thermal jet. In other embodiments, the precursor solution is introduced to the thermal jet by a piezoelectric crystal induced liquid injector which produces droplets greater than about 50 micrometers and having lower velocity. The precursor solution can be injected into the thermal jet internally or externally, radially or coaxially. When the precursor solution is injected radially, the injector nozzle can be oriented at an angle of about 45° to about 90° relative to the axis of the jet. Preferably the injector nozzle is oriented at about 90° relative to the jet axis, or somewhat at an upstream angle. The injection parameters may impact the porosity of the deposited material and the presence or absence of through-coating-thickness microcracks. Multiple radial injectors can be used to increase deposition efficiency.

The precursor solution comprises solvent and metal ion precursors to the YAG-based ceramic. The metal ion precursors include the metal ions described above in the context of the YAG-based ceramic structure, and they further comprise anions. In some embodiments, the metal ion precursors to the YAG-based are provided in the form of a salt selected from the group consisting of carboxylate salts (including acetate salts, propionate salts, and citrate salts), alkoxide salts (including methoxide salts, ethoxide salts, 1-propoxide salts, and 2-propoxide salts), carbonate salts (including bicarbonate salts), halide salts (including fluoride salts, chloride salts, bromides salts, and iodide salts), nitrate salts, hydrates of the foregoing salts, and combinations thereof.

In some embodiments, the precursor solution comprises yttrium nitrate and aluminum nitrate.

The precursor solution comprises a solvent. Suitable solvents include, for example, water, methanol, ethanol, 1-propanol, 2-propanol, ethylene glycol, dimethylsulfoxide (DMSO), acetonitrile, dimethylformamide (DMF), ethyl acetate, formic acid, acetone, methyl ethyl ketone, and the like, and mixtures thereof. The solvent can include a flammable organic material, such as urea or ammonium acetate, that is intentionally included to increase the temperature of the thermal jet. In some embodiments, the solvent comprises water, ethanol, or a mixture thereof. The precursor solution typically contains at least two metal ion salts. The total concentration of metal ion salts in the precursor solution can vary according to the identities of the salts and their solubilities in the solvent. In some embodiments, the total concentration of metal ion salts in the precursor solution is as less than or equal to about 80 weight percent, specifically less than or equal to 70 weight percent, based on the total weight of the precursor solution. There is no particular limitation on the metal ion salt concentration in the precursor solution, but for coating efficiency it may be preferred to use a metal ion salt concentration of at least 1 weight percent, specifically at least 5 weight percent, more specifically at least 10 weight percent, even more specifically at least 20 weight percent. The molar ratio of metal ions in the precursor solution will typically reflect their respective concentration in the YAG-based ceramic formed by the process. For example, when the YAG-based ceramic is YAG itself (that is, yttrium aluminum garnet), the molar ratio of yttrium ions to aluminum ions will typically approximate the 3:5 molar ratio of yttrium to aluminum in YAG. Thus, in some embodiments, the mole ratio of yttrium to aluminum is 2 to 4 moles yttrium:4 to 6 moles aluminum. In some embodiments the composition of the precursor is deliberately adjusted to account for material lost in the spray process by sublimation, evaporation, and so on.

In some embodiments, the precursor solution is a homogeneous solution. The precursor solution is therefore distinguished from sols and suspensions comprising solid materials.

Once in the thermal jet, the precursor solution droplets are, optionally, fragmented. Solvent is evaporated from the precursor solution droplets to form unpyrolyzed solid particles. Without being bound by theory, it is believed that in some cases upon entering the thermal jet the droplets form a crust. As the solvent portion of the droplet inside the crust vaporizes the droplet can explode resulting in the formation of a large number of very small droplets and/or particles. Alternatively the droplet may be fragmented by a dynamic interaction between the velocity of the droplet and the velocity of the jet. In still other embodiments, the entering droplets are small enough or robust enough that no fragmentation occurs in the thermal jet. Independent of whether droplet fragmentation has occurred, solvent is evaporated from the precursor solution, and at least some of the resulting unpyrolyzed solid particles are pyrolyzed in the thermal jet to form pyrolyzed solid particles comprising a YAG-based ceramic. Pyrolysis is defined herein as the conversion of the metal ion precursors to the desired YAG-based ceramic without substantial degradation. For example, pyrolysis of the particles containing yttrium and aluminum cations yields yttrium aluminum garnet.

At least a portion of the pyrolyzed solid particles are melted in the thermal jet to form droplets comprising the YAG-based ceramic. The melting can be partial or complete. The droplets are then deposited on a substrate to form the thermal barrier coating. There is no particular limitation on the substrate, as long as it is thermally and structurally stable to the impact of the pyrolyzed solid particles. Suitable substrates for thermal spray coating include, for example, metals (including steel, stainless steel, nickel-based superalloys, aluminum, and titanium), ceramics, and heat-resistant plastics.

One advantage of the present solution precursor plasma spray process over the air plasma spray process is the deposition on the substrate of smaller units of material than deposited by air plasma spray. For example, in some embodiments, depositing the droplets comprising the YAG-based ceramic on the substrate forms splats on the substrate. The splats can have an average diameter less than or equal to 10 micrometers, specifically less than or equal to 5 micrometers, more specifically less than or equal to 4 micrometers, even more specifically less than or equal to 2 micrometers. A splat is defined as a thin platelet formed when the YAG-based ceramic droplets impinge on the substrate. Splats can typically be described as having a length, width, and thickness. For convenience, the diameter is herein defined as the length or the width, whichever is greater. In some embodiments, the splats have a thickness less than or equal to about 800 nanometers, specifically less than or equal to about 700 nanometers, and more specifically less than or equal to about 600 nanometers.

In some embodiments, the method further comprises depositing pyrolyzed solid particles comprising YAG-based ceramic on the substrate (that is, co-depositing the droplets and the pyrolyzed solid particles).

One important advantage of the present method is its ability to form thermal barrier coatings with through-coating-thickness microcracks. The presence of through-coating-thickness microcracks is associated with significantly improved strain tolerance for the thermal barrier coating. Without being bound by theory, it is believed that the deposition of unpyrolyzed and incompletely pyrolyzed solid particles contributes to the formation of through-coating-thickness microcracks in the thermal barrier coating, because pyrolysis of the unpyrolyzed and incompletely pyrolyzed solid particles on the substrate surface causes a volume change that promotes formation of the through-coating-thickness microcracks. Thus, in some embodiments, the method further comprises depositing incompletely pyrolyzed solid particles and/or the unpyrolyzed solid particles on the substrate and pyrolyzing the incompletely pyrolyzed solid particles and/or the unpyrolyzed solid particles on the substrate. To maximize the stress-relief advantages associated with the through-coating-thickness microcracks, these microcracks can be spaced from each other at a distance, on average, of less than or equal to half the coating thickness.

The through-coating-thickness microcracks typically have a width of about 0.1 to about 5 micrometers, specifically about 0.2 to about 4 micrometers, more specifically about 0.4 to about 3 micrometers, even more specifically about 0.4 to about 2 micrometers. As is implied by their name, the through-coating-thickness microcracks extend through the entire thickness of the coating. In some embodiments, the thermal barrier coating further comprises additional microcracks that penetrate at least half the coating thickness and less than the complete coating thickness.

The droplets comprising the YAG-based ceramic are typically deposited over multiple passes to form the thermal barrier coating. Thus, a wide range of coating thicknesses can be produced. For example, the thermal barrier coating can have a thickness of about 1 micrometer to about 5 millimeters, specifically about 10 micrometers to about 2 millimeters, more specifically about 50 micrometers to about 1 millimeter, still more specifically about 100 micrometers to about 500 micrometers, even more specifically about 200 micrometers to about 500 micrometers. In some embodiments, the thermal barrier coating has a thickness of about 50 to about 5,000 micrometers.

The presence of porosity in the thermal barrier coating is associated with improved (reduced) thermal conductivity and improved strain tolerance. In some embodiments, the thermal barrier coating has a porosity of about 10 to about 40 volume percent based on the total volume of the thermal barrier coating. Porosity can be determined by quantitative examination of the microstructure, or by the Archimedes method.

In some embodiments, the thermal barrier coating comprises inter-pass boundaries. Inter-pass boundaries reduce thermal conductivity. The inter-pass boundaries can have a thickness of about 0.1 to about 2 micrometers, specifically about 0.5 to about 2 micrometers. The porosity of the inter-pass boundary can affect the overall thermal conductivity of the deposited material. The porosity of the inter-pass boundary can be about 20 to about 95 volume percent, specifically about 20 to about 75 volume percent, more specifically about 20 to about 50 volume percent, based on the total volume of the inter-pass boundary. The inter-pass boundaries can exhibit a layered spacing of about 1 to about 10 micrometers. The inter-pass boundaries can be continuous or discontinuous.

In a very specific embodiment of the method, the YAG-based ceramic has the empirical formula Y₃Al₅₋ₓFeₓO₁₂, where x can vary continuously from 0 to 5; the precursor solution is a homogeneous solution; the precursor solution comprises yttrium nitrate and at least one of aluminum nitrate and ferric nitrate; the thermal barrier coating has a thickness of about 50 to about 5,000 micrometers; the method further comprises depositing incompletely pyrolyzed solid particles and/or the unpyrolyzed solid particles and/or on the substrate and pyrolyzing the incompletely pyrolyzed solid particles and/or the unpyrolyzed solid particles on the substrate; the thermal barrier coating comprises through-coating-thickness microcracks having a width of about 0.1 to about 5 micrometers; the through-coating-thickness microcracks are spaced from each other at a distance, on average, of less than or equal to half the coating thickness; and the thermal barrier coating has a porosity of about 10 to about 40 volume percent based on the total volume of the thermal barrier coating.

The invention includes thermal barrier coatings prepared by any of the above-described variations of the method.

One embodiment is a thermal barrier coating having a thickness of about 50 to about 5,000 micrometers and comprising through-coating-thickness microcracks having a width of about 0.1 to about 5 micrometers and spaced from each other at a distance, on average, of less than or equal to half the coating thickness; wherein the thermal barrier coating comprises a YAG-based ceramic. Within the range of about 0.1 to about 5 micrometers, the through-coating-thickness microcracks can have a width of about 0.2 to about 4 micrometers, specifically about 0.4 to about 3 micrometers, more specifically about 0.4 to about 2 micrometers.

The invention includes articles comprising the thermal barrier coating. The thermal barrier coating is particularly suitable for use on hot-section components in gas turbine engines for jet aircraft and power generation and the like. Other applications include use in diesel engines, dielectric coatings, catalytic films, doped oxide films for use in fuel cells and gas separation and purification, electronic and ionic conductivity membranes and sensor devices. In some embodiments, the article is used in the hot section of a gas turbine, including turbine blades, turbine vanes, turbine blade outer air seals, and combustor liner segments.

The invention includes at least the following embodiments.

Embodiment 1: A method of forming a thermal barrier coating, comprising: injecting a precursor solution into a thermal jet; wherein the precursor solution comprises metal ion precursors to a YAG-based ceramic; evaporating solvent from the precursor solution in the thermal jet to form unpyrolyzed solid particles; pyrolyzing at least a portion of the unpyrolyzed solid particles in the thermal jet to form pyrolyzed solid particles comprising a YAG-based ceramic; melting at least a portion of the pyrolyzed solid particles in the thermal jet to form droplets comprising the YAG-based ceramic; and depositing the droplets comprising the YAG-based ceramic on a substrate to form a thermal barrier coating.

Embodiment 2: The method of embodiment 1, wherein the YAG-based ceramic has the garnet structure of FIG. 1 comprising “C” sites, “A” sites, and “D” sites; wherein the “C” cites are occupied by one or a mixture of trivalent metal ions selected from the group consisting of yttrium ions, scandium ions, lutetium ions, lanthanum ions, cerium ions, praseodymium ions, neodymium ions, promethium ions, samarium ions, europium ions, gadolinium ions, terbium ions, dysprosium ions, holmium ions, erbium ions, thulium ions, ytterbium ions; and wherein the “A” and “D” sites are independently occupied by one or a mixture of trivalent metal ions selected from the group consisting of aluminum ions, gallium ions, iron ions, chromium ions, and scandium ions.

Embodiment 3: The method of embodiment 1, wherein the YAG-based ceramic has the garnet structure of FIG. 1 comprising “C” sites, “A” sites, and “D” sites; wherein the “C” cites are occupied by yttrium ions; and wherein the “A” and “D” sites are independently occupied by one or a mixture of metal ions selected from the group consisting of aluminum ions, iron ions, gallium ions, and scandium ions.

Embodiment 4: The method of embodiment 1, wherein the YAG-based ceramic has the garnet structure of FIG. 1 comprising “C” sites, “A” sites, and “D” sites; wherein the “C” cites are occupied by one or a mixture of metal ions selected from the group consisting of yttrium ions, cerium atoms, neodymium atoms, terbium atoms, and ytterbium atoms; and wherein the “A” and “D” sites are occupied by aluminum ions.

Embodiment 5: The method of embodiment 1, wherein the YAG-based ceramic has the empirical formula Y₃Al₅₋ₓFeₓO₁₂, where x can vary continuously from 0 to 5.

Embodiment 6: The method of embodiment 1, wherein the YAG-based ceramic comprises yttrium aluminum garnet (Y₃Al₅O₁₂).

Embodiment 7: The method of any of embodiments 1-6, wherein the precursor solution is a homogeneous solution.

Embodiment 8: The method of any of embodiments 1-7, wherein the metal ion precursors to the YAG-based ceramic are provided in the form of a salt selected from the group consisting of carboxylate salts, alkoxide salts, carbonate salts, halide salts, nitrate salts, hydrates of the foregoing salts, and combinations thereof.

Embodiment 9: The method of any of embodiments 1-8, wherein the precursor solution comprises yttrium nitrate and aluminum nitrate.

Embodiment 10: The method of any of embodiments 1-9, wherein said depositing the droplets comprising the YAG-based ceramic on the substrate forms splats on the substrate, the splats comprising the YAG-based ceramic; wherein the splats have an average diameter less than or equal to 5 micrometers.

Embodiment 11: The method of any of embodiments 1-10, wherein the thermal barrier coating has a thickness of about 1 to about 5,000 micrometers.

Embodiment 12: The method of any of embodiments 1-11, further comprising incompletely pyrolyzing at least a portion of the unpyrolyzed solid particles in the thermal jet to form incompletely pyrolyzed solid particles; depositing the incompletely pyrolyzed solid particles and/or the unpyrolyzed solid particles on the substrate; and pyrolyzing the incompletely pyrolyzed solid particles and/or the unpyrolyzed solid particles on the substrate.

Embodiment 13: The method of embodiment 12, wherein said pyrolyzing the unpyrolyzed solid particles and/or incompletely pyrolyzed solid particles on the substrate forms through-coating-thickness microcracks in the thermal barrier coating.

Embodiment 14: The method of embodiment 13, wherein the thermal barrier coating has a thickness; and wherein the through-coating-thickness microcracks are spaced from each other at a distance, on average, of less than or equal to half the coating thickness.

Embodiment 15: The method of embodiment 13, wherein the through-coating-thickness microcracks have a width of about 0.1 to about 5 micrometers.

Embodiment 16: The method of any of embodiments 1-15, wherein the thermal barrier coating has a porosity of about 10 to about 40 volume percent based on the total volume of the thermal barrier coating.

Embodiment 17: The method of any of embodiments 1-16, wherein the thermal barrier coating comprises inter-pass boundaries.

Embodiment 18: The method of embodiment 1, wherein the YAG-based ceramic has the empirical formula Y₃Al₅₋ₓFeₓO₁₂, where x can vary continuously from 0 to 5; wherein the precursor solution is a homogeneous solution; wherein the precursor solution comprises yttrium nitrate and at least one of aluminum nitrate and ferric nitrate; wherein the thermal barrier coating has a thickness of about 50 to about 5,000 micrometers; wherein the method further comprises depositing incompletely pyrolyzed solid particles and/or the unpyrolyzed solid particles on the substrate and pyrolyzing the incompletely pyrolyzed solid particles and/or the unpyrolyzed solid particles on the substrate; wherein the thermal barrier coating comprises through-coating-thickness microcracks having a width of about 0.1 to about 5 micrometers; wherein the through-coating-thickness microcracks are spaced from each other at a distance, on average, of less than or equal to half the coating thickness; and wherein the thermal barrier coating has a porosity of about 10 to about 40 volume percent based on the total volume of the thermal barrier coating.

Embodiment 19: 19. A thermal barrier coating prepared by the method of any of embodiments 1-18.

Embodiment 20: A thermal barrier coating having a thickness of about 50 to about 5,000 micrometers and comprising through-coating-thickness microcracks having a width of about 0.1 to about 5 micrometers and spaced from each other at a distance, on average, of less than or equal to half the coating thickness; wherein the thermal barrier coating comprises a YAG-based ceramic.

Embodiment 21: The thermal barrier coating of embodiment 20, wherein the YAG-based ceramic has the empirical formula Y₃Al₅₋ₓFeₓO₁₂, where x can vary continuously from 0 to 5; wherein the YAG-based ceramic has the empirical formula Y₃Al₅₋ₓFeₓO₁₂, where x can vary continuously from 0 to 5; and wherein the thermal barrier coating comprises inter-pass boundaries and splats having an average diameter less than or equal to 5 micrometers.

Embodiment 22: An article comprising the thermal barrier coating of any of embodiments 19-21.

Embodiment 23: The article of embodiment 22, wherein the article is used in the hot section of a gas turbine and selected from turbine blades, turbine vanes, turbine blade outer air seals, and combustor liner segments.

The invention is further illustrated by the following non-limiting examples.

### EXAMPLE 1

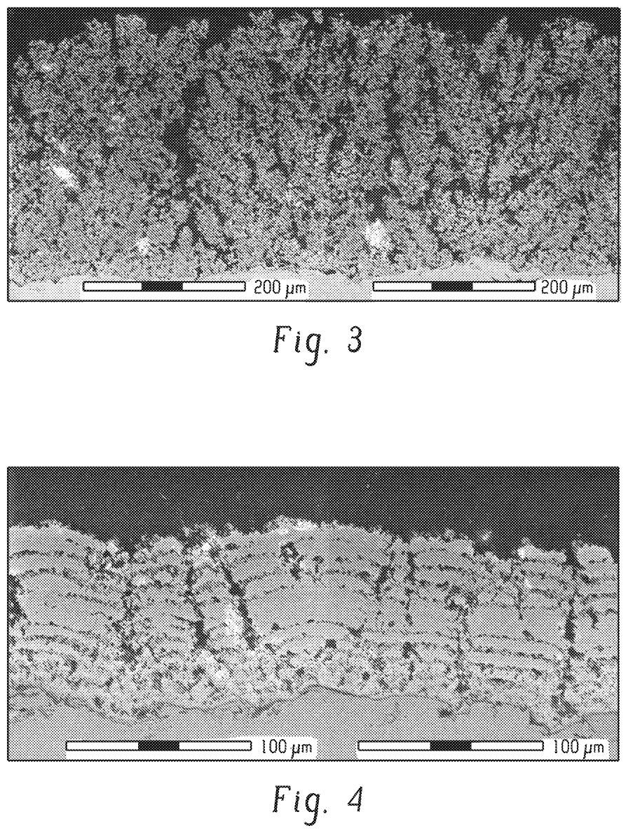

Thermal barrier coatings were generated with a Sulzer-Metco Plasma Spray System that included a 9MC controller, a 9MB plasma torch, and a Bete atomizing nozzle. The precursor solution was a homogeneous aqueous solution of yttrium nitrate and aluminum nitrate in an yttrium to aluminum mole ratio of 3:5. The precursor solution was prepared from 1000 milliliters deionized water, 584.7 grams yttrium nitrate hexahydrate, and 952 grams aluminum nitrate nonahydrate, yielding a solution with 5.35 weight percent yttrium and 2.70 weight percent aluminum. Spray coating was conducted using an argon primary gas flow of 80 to 140 standard cubic feet per hour (SCFH) at 100 pounds per square inch (689 kilopascals), a hydrogen secondary gas flow of 8 to 20 SCFH at 50 pounds per square inch (345 kilopascals), a plasma current of 600 amps, and a plasma voltage of 65 volts. The precursor solution was atomized using the Bete atomizing nozzle at a rate of 25 milliliters per minute. The plasma jet at the substrate was hotter for the dense microstructure of FIG. 4 because the stand-off distance was 1.375 inches (3.4925 centimeters), compared to 1.75 inches (4.445 centimeters) for the feathery microstructure of FIG. 3. The inter-pass boundaries were produced with the dense microstructure of FIG. 4 because the plasma torch raster scan height was 1 millimeter for the dense microstructure, compared to 3 millimeters for the feathery microstructure of FIG. 3. The reduced raster scan height captured more semi-pyrolyzed and unpyrolyzed material, thus producing the inter-pass boundaries.

These experiments illustrate that thermal barrier coatings comprising YAG-based ceramics can be produced with highly varied microstructures by varying thermal spray processing parameters.

### EXAMPLE 2

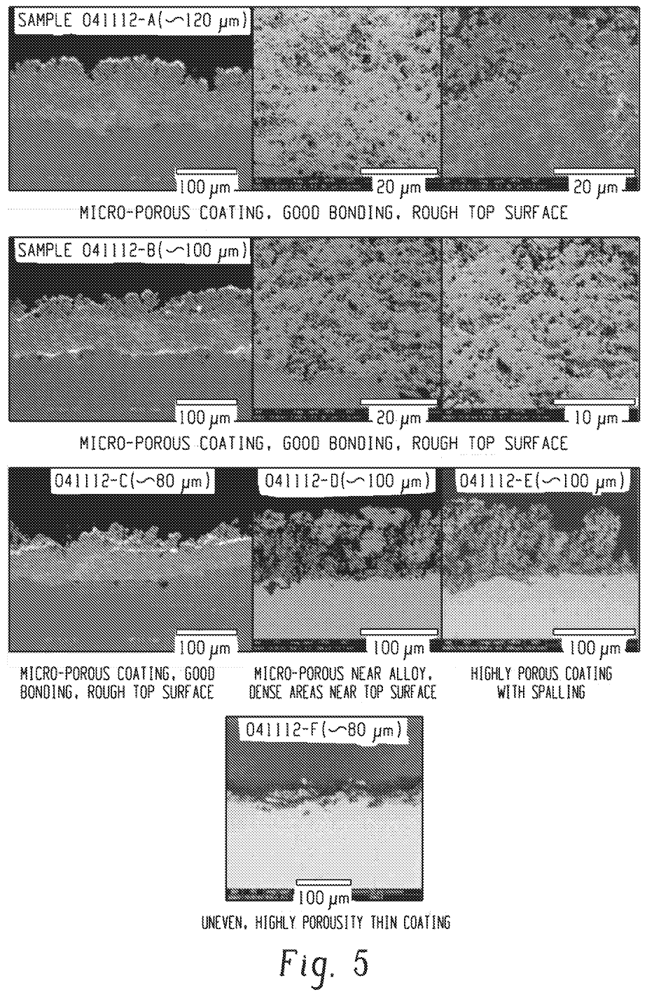

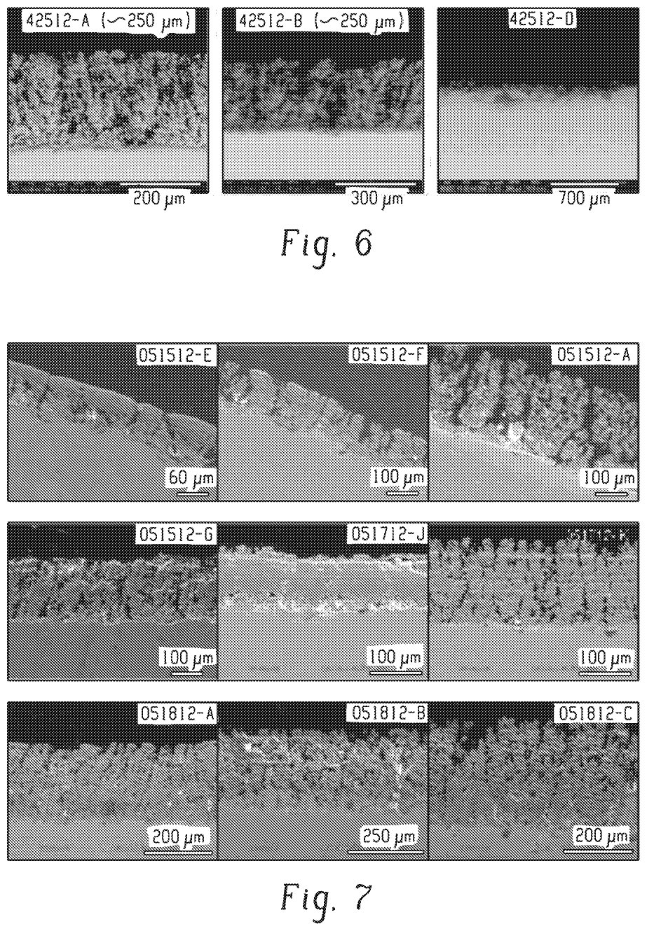

In this experiment, the following SPPS process parameters were studied: (1) stand-off distance (gun to substrate distance), (2) radial distance (atomizing nozzle tip to plasma plume distance), (3) plasma power, and (4) precursor feed rate. In Table 2, “Index” is the raster scan height of the plasma gun in successive traverses of the specimen. In initial spray trials, summarized in Tables 2 and 3, 50/50 deionized water/ethanol was used as the solvent. The precursor solution was as described in Example 1. These initial trials demonstrated that uniform micro-porous YAG coatings (samples 041112-A and 041112-B; FIG. 5) can be deposited when the standoff distance is less than 1.75″. Thermal barrier coatings 250 micrometer thick were also achieved (Samples II-A and II-B) at such standoff distances (FIG. 6).

TABLE 2
Spray conditions for first set of YAG SPPS spray trials
Precursor solution: YAG mixed with 50/50 Water-Ethanol (V/V) solution
Injection Bete Atomizing

| Sample # | Index | Standoff distance |
|---|---|---|
| 041112-A | 2 mm | 1.625″ |
| 041112-B | 2 mm | 1.75″ |
| 041112-C | 2 mm | 1.875″ |
| 041112-D | 1 mm | 1.625″ |
| 041112-E | 1 mm | 1.75″ |
| 041112-F | 1 mm | 1.875″ |

TABLE 3
Spray conditions for second set of SPPS YAG spray trials
Solution: 50/50 Water/Ethanol (V/V) Solution
Bete Atomizing; Feed rate: 15~18 mL/min

| Sample # | Index | Standoff distance | Scan speed |
|---|---|---|---|
| 042512-A | 2 mm | 1.625″ | 450 mm/s |
| 042512-B | 2 mm | 1.750″ | 450 mm/s |
| 042512-D | 2 mm | 1.875″ | 450 mm/s |
| 042512-E | 2 mm | 1.625″ | 225 mm/s |
| 042512-F | 2 mm | 1.750″ | 225 mm/s |
| 042512-G | 2 mm | 1.875″ | 225 mm/s |
| 042512-H | 2 mm | 2″ | 225 mm/s |

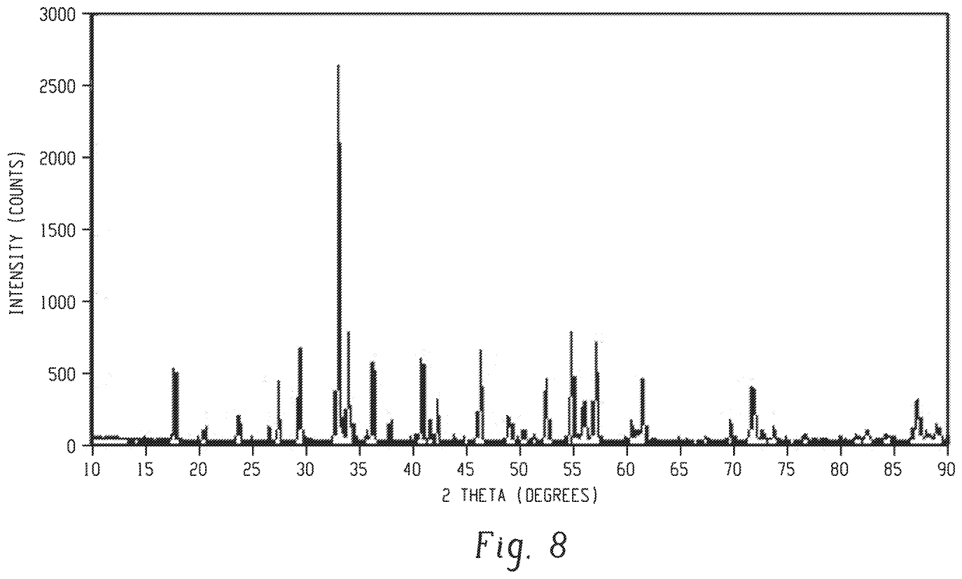

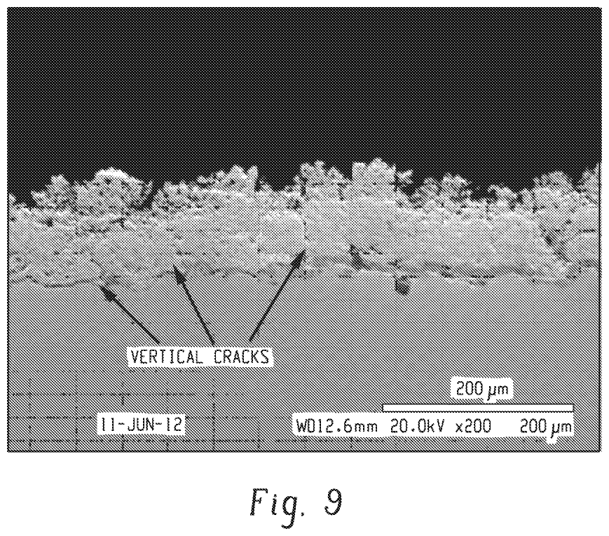

In order to increase the particle temperature during the spray, 5 weight percent urea or ammonium acetate was added into the solution as “fuel” to enhance the melting of the YAG particles and increase the coating density and mechanical properties. Conditions are summarized in Table 4, where “SD” is stand-off distance, and “Delay” is the delay in seconds between passes. The micrographs shown in FIG. 7 indicate that addition of ammonium acetate or urea does enhance the melting of YAG particles and thereby the density of the coatings. A sample sprayed with ammonium acetate (sample 051512-E) with a close standoff distance (1.375″) had a nearly fully dense top layer. A thermal barrier coating specimen with urea addition (051512-J, standoff distance 1.375″) had uniform dense layers and vertical cracks. Another specimen, 051512-A (standoff distance 1.375″), without the addition of ammonium acetate or urea, also showed good hardness with uniform columnar microstructure and micro porosity. Larger standoff distances (051512-B and 051512-C) tended to generate higher porosity especially on the coating top surfaces. It was also observed that a predetermined delay during different spray passes reduced the melting of YAG particles and increased the porosity (051512-G). X-ray diffraction patterns (FIG. 8) indicated that the as-sprayed SPPS YAG sample (III-A) contains mainly the YAG phase with very small amounts of YAM and YAP, which may due to the insufficient thermal treatment of some precursor droplets that traveled outside of the plasma plume. Heat treatment (1100° C., 1 hour) of SPPS YAG samples with uniform micro-porosity (041112-A and 041112-B) was shown to generate vertical cracks, which are highly desired for enhanced coating compliance, with a spacing of about 100 micrometers (FIG. 9). It was anticipated that this microstructure would be highly strain-tolerant.

TABLE 4
Spray conditions

| Sample # | Precursor Solution | Injection | SD | Delay | Index |
|---|---|---|---|---|---|
| 051512-A | YAG w/Ammonium Acetate | Bete Atomizing | 1.75″ | No | 3 mm |
| 051512-B | YAG w/Ammonium Acetate | Bete Atomizing | 1.875″ | No | 3 mm |
| 051512-C | YAG w/Ammonium Acetate | Bete Atomizing | 2″ | No | 3 mm |
| 051512-E | YAG w/Ammonium Acetate | Bete Atomizing | 1.375″ | No | 3 mm |
| 051512-F | YAG w/Ammonium Acetate | Bete Atomizing | 1.5″ | No | 3 mm |
| 051512-G | YAG w/Ammonium Acetate | Bete Atomizing | 1.375″ | 30 s | 3 mm |
| 051512-H | YAG w/Ammonium Acetate | Bete Atomizing | 1.5″ | 30 s | 3 mm |
| 051512-I | YAG w/Ammonium Acetate | Bete Atomizing | 1.625″ | 30 s | 3 mm |
| 051512-J | YAG w/Urea | Bete Atomizing | 1.375″ | 30 s | 3 mm |
| 051512-K | YAG w/Urea | Bete Atomizing | 1.5″ | 30 s | 3 mm |
| 051512-L | YAG w/Urea | Bete Atomizing | 1.625″ | 30 s | 3 mm |
| 051512-M | YAG w/Urea | Bete Atomizing | 1.75″ | No | 3 mm |
| 051512-N | YAG w/Urea | Bete Atomizing | 1.875″ | No | 3 mm |
| 051512-O | YAG w/Urea | Bete Atomizing | 2″ | No | 3 mm |
| 051812-A | YAG | Bete Atomizing | 1.375″ | 30 s | 3 mm |
| 051812-B | YAG | Bete Atomizing | 1.5″ | 30 s | 3 mm |
| 051812-C | YAG | Bete Atomizing | 1.625″ | 30 s | 3 mm |

EXAMPLE 3

These examples represent a Taguchi experimental design to optimize the microstructure of YAG thermal barrier coatings. The process variables were water/ethanol ratio, standoff distance, and radial distance. Experimental conditions are summarized in Table 5.

TABLE 5
Spray conditions
Bete Atomizing FC14, Feed rate: 15 ml/min, scan speed 650 mm/s,
radial distance 5.5 mm (A5/B5/C5), 7.5 mm (A7/B7/C7)

| Sample Set 073112-A | | | Sample Set 073112-B | | | Sample Set 073112-C | | |
|---|---|---|---|---|---|---|---|---|
| 50/50 DI water/ethanol | | | 75/25 DI water/ethanol | | | 25/75 DI water/ethanol | | |
| Sample | | Standoff | Sample | | Standoff | Sample | | Standoff |
| # | Index | distance | # | Index | distance | # | Index | distance |
| A5A | 2 mm | 1.5″ | B5A | 2 mm | 1.5″ | C5A | 2 mm | 1.5″ |
| A5B | 2 mm | 1.625″ | B5B | 2 mm | 1.625″ | C5B | 2 mm | 1.625″ |
| A5C | 2 mm | 1.75″ | B5C | 2 mm | 1.75″ | C5C | 2 mm | 1.75″ |
| A5D | 2 mm | 1.875″ | B5D | 2 mm | 1.875″ | C5D | 2 mm | 1.875″ |
| A7A | 2 mm | 1.5″ | B7A | 2 mm | 1.5″ | C7A | 2 mm | 1.5″ |
| A7B | 2 mm | 1.625″ | B7B | 2 mm | 1.625″ | C7B | 2 mm | 1.625″ |
| A7C | 2 mm | 1.75″ | B7C | 2 mm | 1.75″ | C7C | 2 mm | 1.75″ |
| A7D | 2 mm | 1.875″ | B7D | 2 mm | 1.875″ | C7D | 2 mm | 1.875″ |

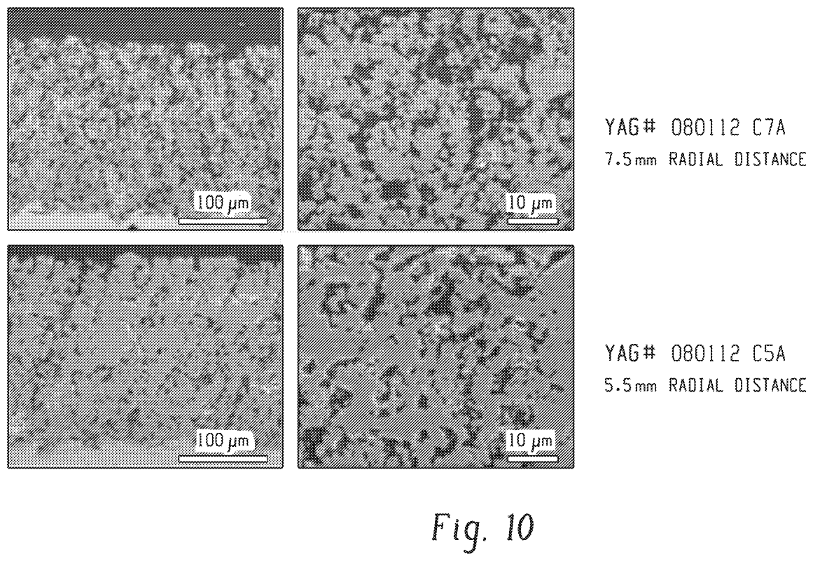

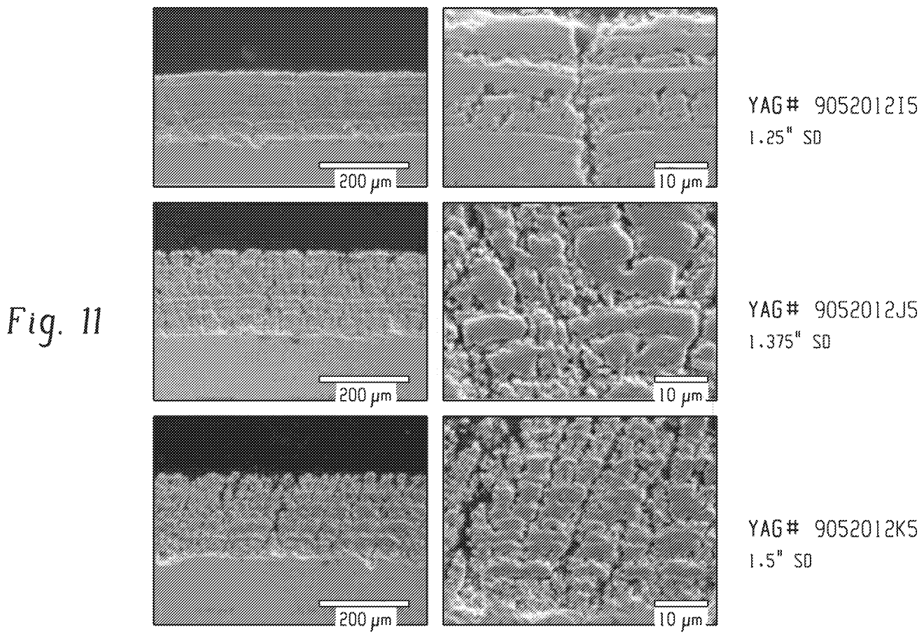

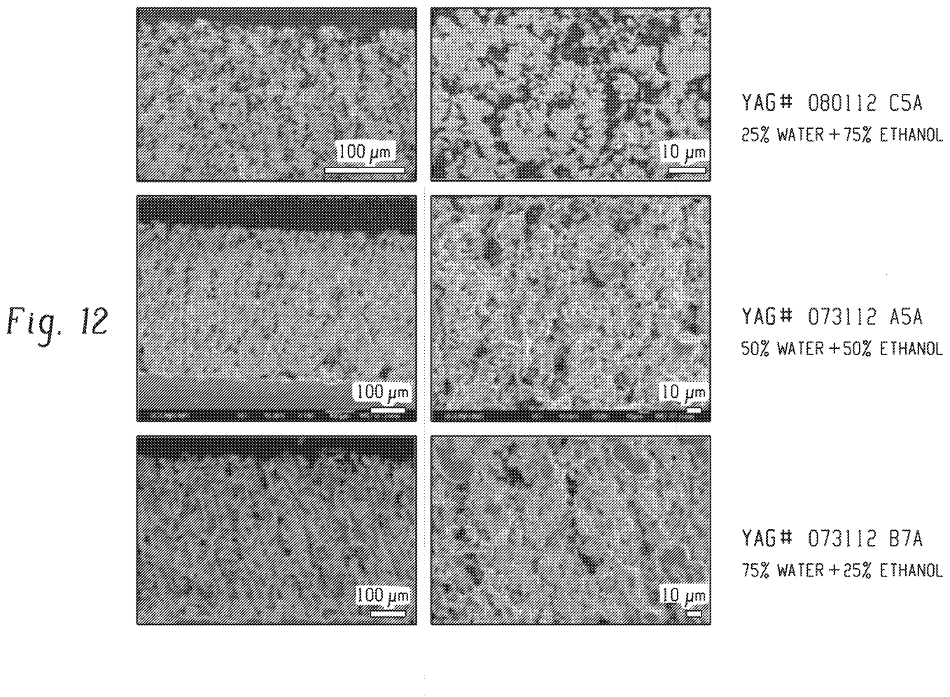

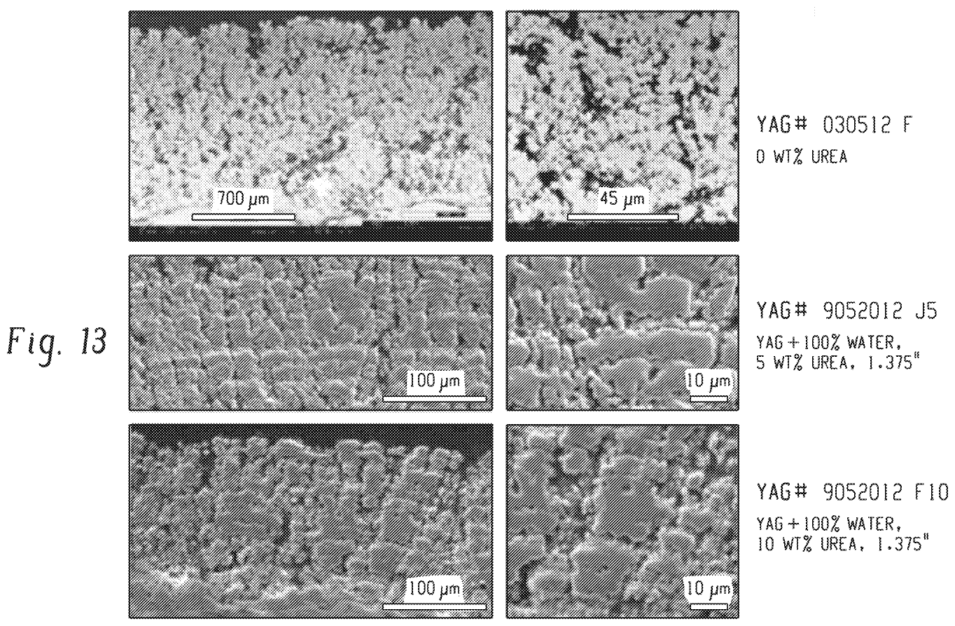

Analysis of the Taguchi designed experiment showed that the key factors that affected the microstructure of SPPS YAG are standoff distance, urea additive, radial distance and water/ethanol ratio. A closer radial distance (5 5 millimeters) combined with suitable feed rate and atomizing pressure helps to keep more precursor droplets in the central area of the plasma plume, which will enhance the melting of the YAG particles. As a result, more dense areas are observed in comparison with a radial distance of 7 5 millimeters (FIG. 10; samples correspond to C5A and C7A in Table 5). A short standoff distance increases the surface temperature of the coating and therefore also enhances the melting of the YAG particles. A fully dense YAG coating with vertical cracks was achieved at a standoff distance of 1.25 inch (FIG. 11). Increasing the standoff distance resulted in a microstructure with uniformly distributed dense areas and a columnar structure (FIG. 11). Higher ethanol concentration also provided more thermal energy during the ethanol combustion and therefore enhanced the melting of YAG particles (FIG. 12). As demonstrated in previous spray trials, adding urea enhanced the melting of YAG particles. See FIG. 13, where the top row images correspond to sample 051512-F in Table 4. There was no significant difference observed in coating microstructure and density with 5 weight percent and 10 weight percent urea addition. The preliminary spray trials and further optimization show that a wide range of microstructure of SPPS YAG was achieved, from highly porous microstructure to high density layered structure with vertical cracks and to nearly fully dense structure. As a result, the micro-hardness (Vickers hardness) of the SPPS YAG coatings varies in a wide range also. Table 6 lists micro-hardness of some samples with typical microstructure.

TABLE 6
Measured Micro-hardness of some of the SPPS YAG samples

| Micro structure | Vickers hardness (HV) |
|---|---|
| Highly porous, “feathery” | 100 |
| “Dense” with vertical cracks | 334 |
| “Dense” columnar structure | 205 |
| Nearly fully dense | 1587 |
| “Dense” columnar structure | 305 |

### EXAMPLE 4

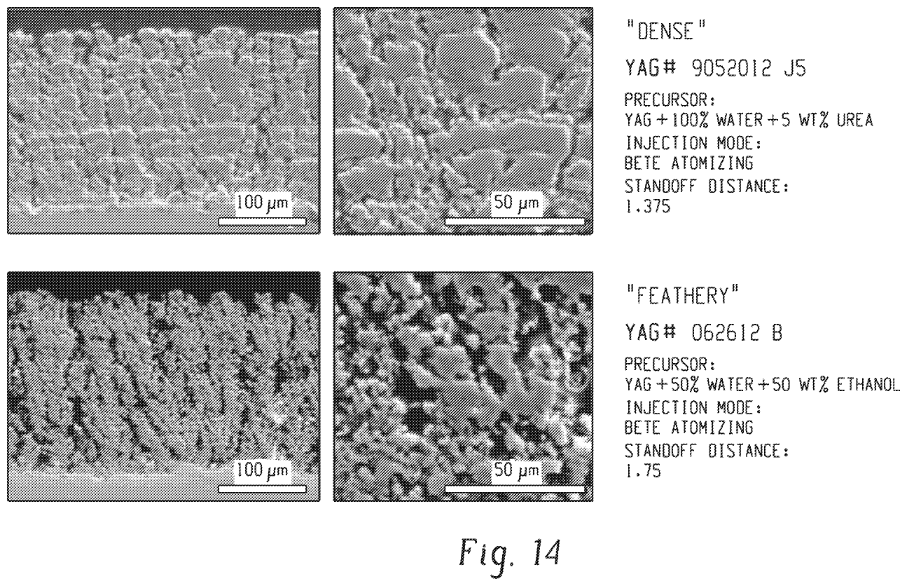

This example describes the deposition of two specific microstructures having the potential for very high strain tolerance (FIG. 14). These included (1) a “dense vertically cracked” structure; and (2) a “feathery” structure. YAG TBCs with 250 micron thickness were sprayed by SPPS on HVOF MCrA1Y bond coated H230 alloy with a thin SPPS YSZ coating (˜75 μm) sprayed between the alloy and SPPS YAG as a diffusion barrier. Preparation of the “dense vertically cracked” structure utilized water without ethanol, 5 weight percent urea, and a standoff distance of 1.375 inches. Preparation of the “feathery” structure utilized a 1:1 weight ratio of water to ethanol, no urea, and a standoff distance of 1.75 inches. Thermal cycling and thermal conductivity tests were conducted at UConn and HiFunda using as-sprayed SPPS YAG coupons.

### EXAMPLE 5

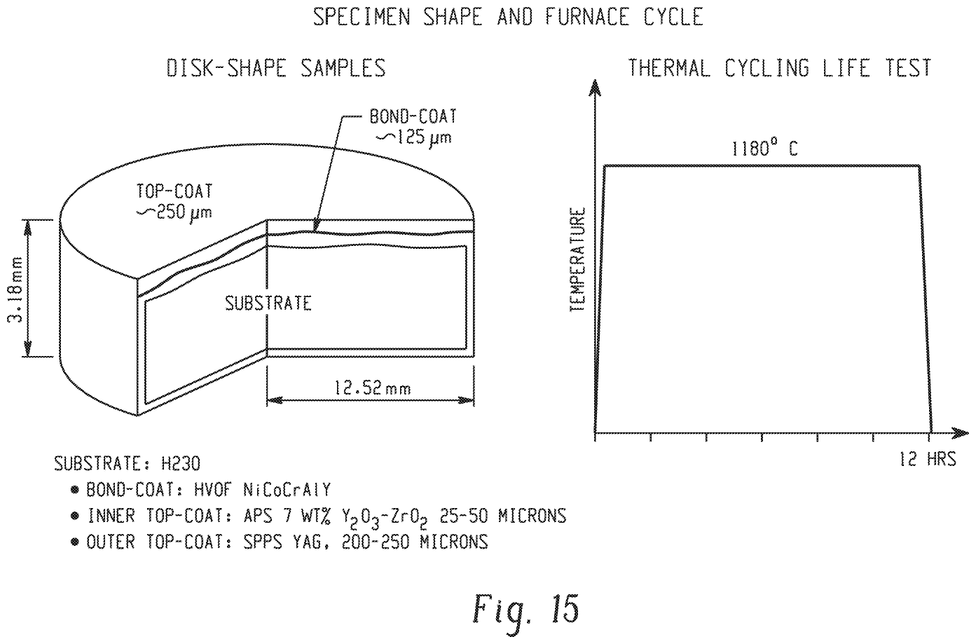

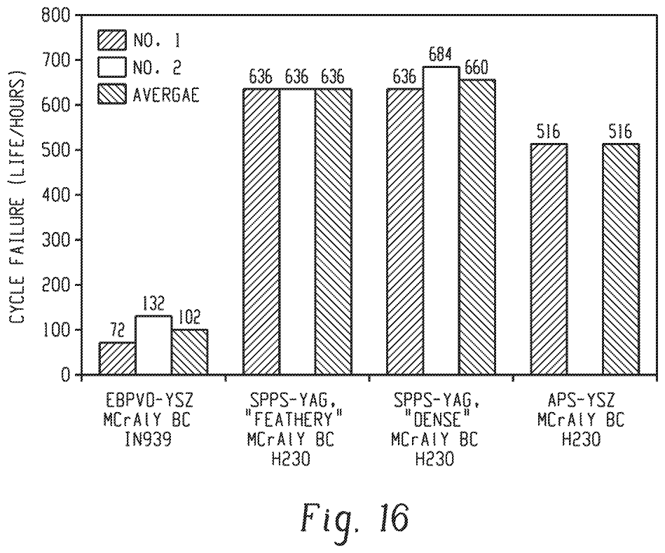

This example describes thermal cycling tests used to characterize the “dense vertically cracked” and “feathery” coatings prepared in Example 4. Two types of thermal cycling tests were carried out. The first type of thermal cycling was conducted at UConn with an “extreme condition”, 12 hour hold-time thermal cycling at 1180° C. See FIG. 15. APS and EB-PVD YSZ baseline samples were also tested with the SPPS YAG samples. Prior test experience with a number of advanced TBCs under these testing condition yielded lifetimes of 60-200 hrs. The results of this testing are presented in FIG. 16. During the test, two EB-PVD YSZ baseline samples failed at 72 and 120 hrs. SPPS YAG samples, for both “feathery” (failed at 636 hours) and “dense” (failed at 660 hours) microstructures, showed superior high-temperature thermal cycling life than one of the baseline and APS YSZ and therefore clearly showed potential to be used as a higher temperature TBC. A second baseline sample was run which used the same base alloy and bond coat as the YAG sample. The YAG TBC sample lasted 27% longer than the baseline sample. In these preliminary tests, SPPS YAG TBCs outperformed both baseline samples, thus demonstrating that the thermal expansion mismatch strains of YAG TBCs can be overcome using the highly strain tolerant SPPS microstructure. This is a key result enabling SPPS YAG TBCs to be used as thermal barrier coatings. Thermal barrier coatings can exhibit life factors of two or more in the same cyclic test. Of note, is the excellent consistency of the lives for the three dense and the three samples with “feathery” microstructure.

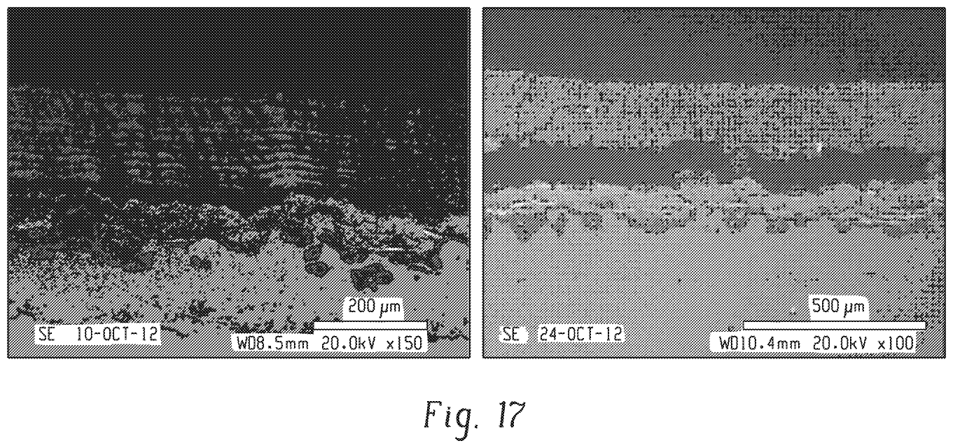

Post-failure SEM analysis indicated that spallation occurs in the SPPS YAG layer, just above the interface with the APS YSZ inner layer (FIG. 17). This spallation location provides optimum thermal cycling durability because it benefits from the strain tolerance of the SPPS microstructure and, being remote from the bond coat and the TGO, it experiences lower stresses. FIG. 17 also shows the uniform vertical cracks in SPPS YAG TBCs that provide strain-tolerant microstructures, thus enhancing thermal cycling durability.

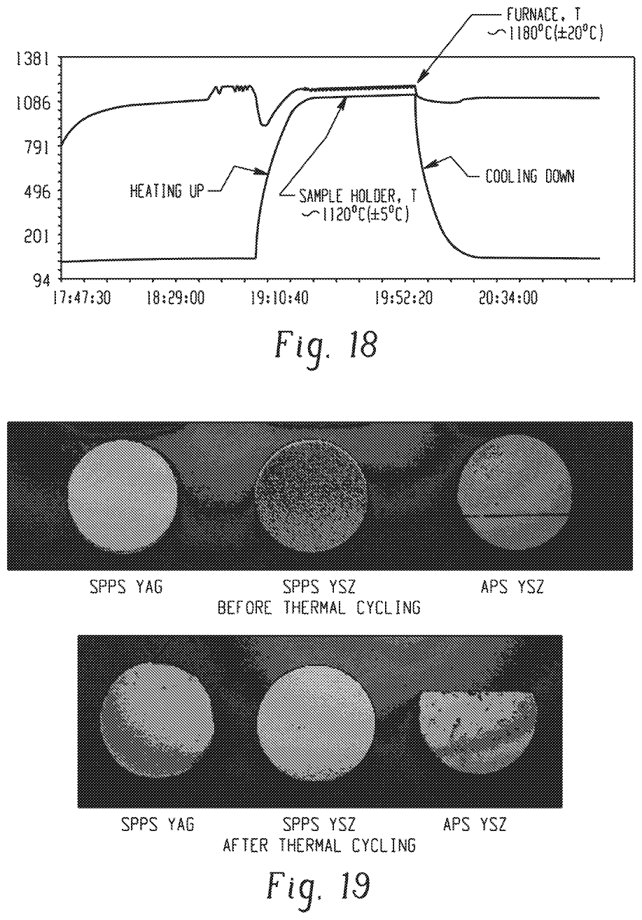

The second type of thermal cycling tests carried out at both HiFunda and UConn using a widely accepted, lower temperature (1121° C.±5° C.) one hour thermal cycling profile with 10 minute heating and cooling ramps. SPPS YAG, SPPS YSZ, and baseline YSZ were tested. The test at HiFunda was conducted in an in-house fabricated, programmable thermal cycling furnace (FIG. 18). The furnace is kept hot and the specimen is inserted in the hot furnace, comes to temperature, is held at temperature for 50 minutes, then the specimen is removed from the furnace and cooled. At the time of this report, the test has reached 400 cycles with no significant spallation for all the samples tested (FIG. 19). The test at UConn was also completed after 400 cycles with no specimen distress on the SPPS YAG TBCs, but the baseline APS YSZ failed at 352 cycles. To summarize, testing at two temperatures and at two testing sources showed SPPS YAG thermal barrier coatings to have a cyclic life equal to or greater than SPPS and APS YSZ thermal barrier coatings. This demonstrates the benefit of the SPPS strain-tolerant microstructure.

Based on previous test data under these conditions, a TBC with poor compliance can fail at under 200 cycles, and 400 cycles are typical for good APS YSZ TBCs. These tests at moderate temperatures and short duration (1121° C./1 hour) and high temperature and long duration (1180° C./12 hours) both confirm the superior durability of SPPS YAG TBCs and the capability of the strain-tolerant microstructure to overcome the larger thermal expansion mismatch strains compared to APS YSZ.

### EXAMPLE 6

This example describes thermal conductivity measurements.

UConn's thermal conductivity measurements of as-sprayed SPPS YAG TBC coatings were made using the laser flash technique. The measurement showed a thermal conductivity of 0.95 W/m-K at 23° C.

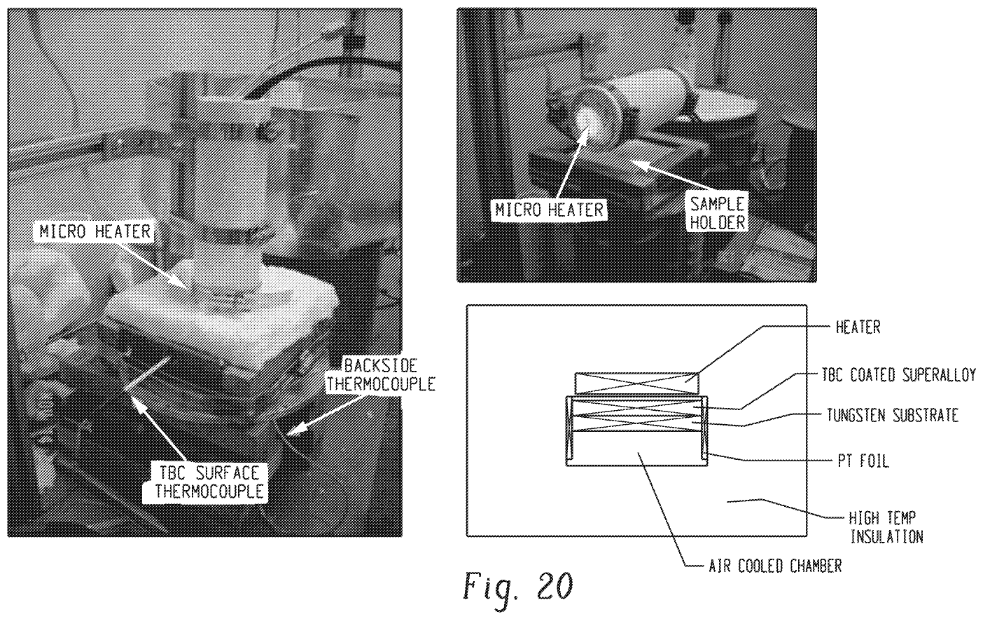

HiFunda carried out experiments designed to estimate “effective” heat transfer coefficients resulting from both conduction and radiation at high-temperature. Initially, the emphasis was on using this technique to perform comparative measurements relative to 7YSZ as opposed to measurements with extreme precision. FIG. 20 shows a schematic of the measurement system built at HiFunda for this purpose. A radiant heater was used to drive heat through the TBC-coated superalloy specimen. The back end of the steel plate was cooled with circulating air. The whole system was encased in thick high temperature ceramic insulation such that the heat flow in all the other directions except for the path through the TBC-coated specimen would be a very small fraction (less than 3%) of the net heat generated by the radiant heater. Thermocouples were attached to the top of the TBC and the back of the superalloy. Knowing the thermal conductivity of the superalloy, the thickness of the TBC coatings and the top and bottom temperatures, the heat flux through the TBC system is estimated and the effective thermal conductivity of the TBCs were calculated.

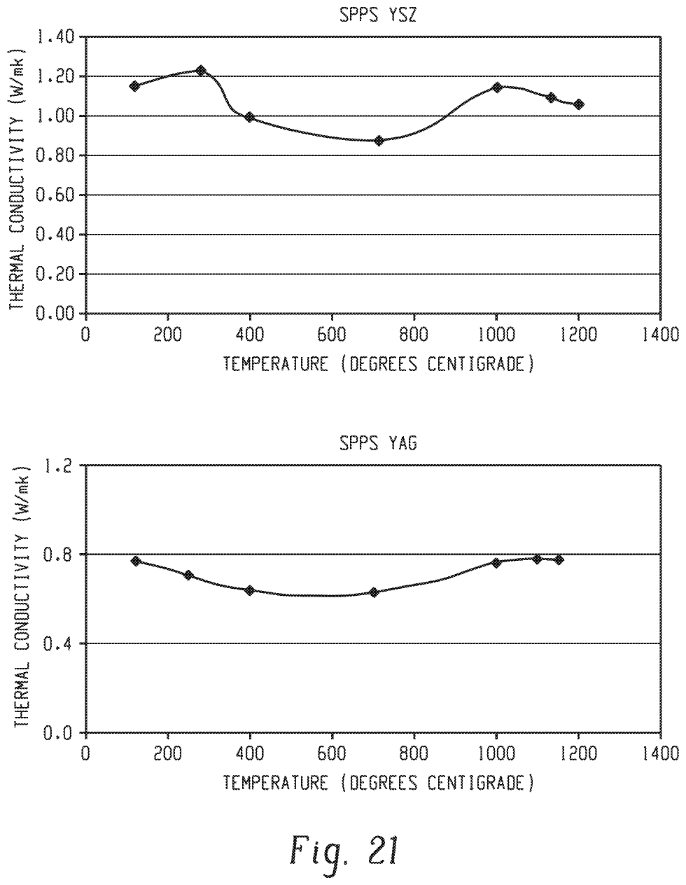

The effective thermal conductivity of as-sprayed SPPS YSZ and the fully dense SPPS YAG coatings as measured by this technique is shown in FIG. 21. The thermal conductivity of SPPS YSZ was between 0.9 and 1.2 Watts/meter·Kelvin (W/m·K) (from 100° C. to 1200° C.), which is coincident with the measurement for SPPS YSZ using a similar approach. The thermal conductivity of SPPS YAG is between 0.6 and 0.8 W/m·K (100° C. to 1200° C.), which is about 30% lower than that of SPPS YSZ. This is attributed to the higher porosity in SPPS YAG coatings and the intrinsically lower thermal conductivity of YAG at high temperature. Both SPPS YSZ and SPPS YAG have lowest thermal conductivity around 700° C. and an increase of thermal conductivity at higher temperature due to the contribution of heat transfer by radiation. The shapes of the effective thermal conductivity measurements observed here are similar to, but lower than (presumably due to the greater porosity in our coatings) previously reported measurements on APS YAG TBCs. N. P. Padture, K. W. Schlichting, T. Bhatia, A. Ozturk, B. Cetegen, E. H. Jordan, M. Gell, S. Jiang, T. D. Xiao, P. R. Strutt, E. Garcia, P. Miranzo And M. I. Osendi, “Towards Durable Thermal Barrier Coatings With Novel Microstructures Deposited By Solution Precursor Plasma Spray,” Acta Materialia 49 (2001) 2251-2257.

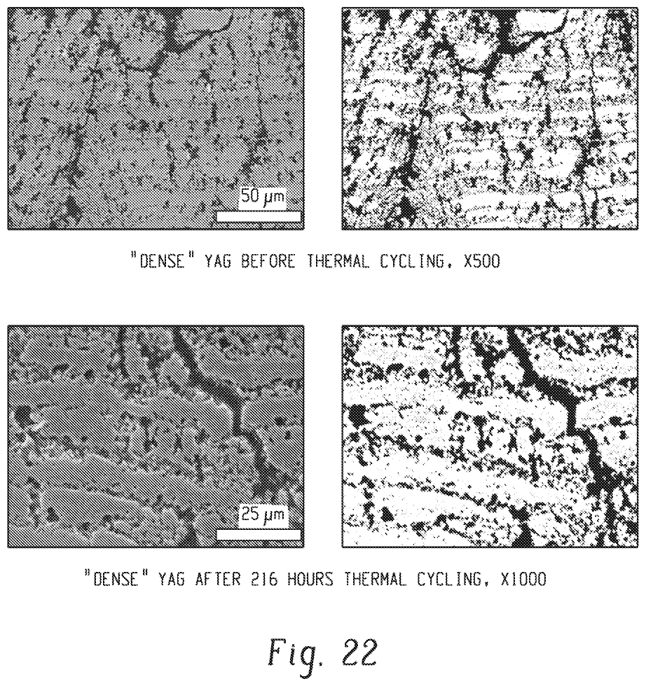

Both thermal conductivity measurements at UConn and HiFunda indicate that SPPS YAG has lower thermal conductivity than SPPS YSZ and conventional APS and EB-PVD YSZ. As shown in FIG. 22, at optical magnifications, the SPPS YAG TBCs show no microstructural change with thermal cycling.

Table 7 summarizes the properties of SPPS YAG in comparison with bulk YAG and YSZ materials. The key advantage of using SPPS YAG as a thermal barrier coating is its higher theoretical operating temperature (1950° C.) in comparison with YSZ (1200-1300° C.). The highest temperature that SPPS YAG coatings have been exposed to in these studies is 1250° C. and SPPS YAG coatings showed superior high-temperature thermal cycling life than baseline and APS YSZ at elevated temperature. Experiments are in progress to evaluate the maximum operating temperature of SPPS YAG. The thermal conductivity of SPPS YAG with a coating density of 2.87 is 0.95, measured at room temperature. The effective thermal conductivity measured between 100° C. and 1200° C. is ˜30% lower than that of SPPS YSZ coatings. SPPS process has the advantage of controlling microstructure via a wide range of variables, such as precursor formulation and spray parameters. As demonstrated in Phase I, the ability to vary coating hardness in a wide range by different microstructure will be important for optimizing erosion resistance, thermal conductivity of YAG thermal barrier coatings and also for applications such as abradable blade outer air seals and graded coatings.

TABLE 7
Properties of SPPS YAG, YAG and YSZ

| Material Property | YSZ (bulk) | YAG (bulk) | SPPS YAG TBCs |
|---|---|---|---|
| Melting Point (° C.) | 2680 | 1950 | 1950 |
| Maximum Operating | 1200-1300 | 1800 | to be determined |
| Temperature (° C.) | | | (1250° C. in initial |
| | | | experiments) |
| Thermal Conductivity at | 2.0-3.0 (measured | 8.7 (measured 23° C.)/2.5 | 0.95 at 23° C. (UConn) |
| 23/1350° C. (W/m-K) | over temp range) | (extrapolated 1350° C.) | 0.8 at 100° C. (HiFunda) |
| Thermal Expansion | 9.5 × 10⁻⁶ | 7.5 × 10⁻⁶ | 7.5 × 10⁻⁶ but stresses |
| Coefficient (ppm/K) | | | reduced by microstructure |
| Density (g/cc) | 6.10 | 4.55 | 2.87 |
| Vickers Hardness (HV) | 1200 | 1700 | 300-1550 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1-18. (canceled)

19. A method for manufacturing a coating, the method comprising:
dissolving at least one salt in a mixture of water and ethanol to form a precursor solution;
adding an additive to the precursor solution to form a fuel solution, wherein the additive comprises at least one of urea or ammonium acetate;
injecting the fuel solution into a plasma flame, wherein the additive functions as a fuel to increase a temperature of the plasma flame; and
manufacturing the coating on a substrate, wherein the coating comprises:
a garnet structure including a predetermined amount of yttrium-aluminum;
one or more first cracks extending completely through a thickness of the coating; and
a porosity greater than ten volume percent.

20. The method of claim 19, wherein the manufactured coating further comprises:
a plurality of first cracks extending completely through the thickness of the coating, wherein
the plurality of first cracks are spaced apart a distance that is less than or equal to half the thickness of the coating.

21. The method of claim 19, wherein:
the garnet structure comprises (C) sites, (A) sites, and (D) sites;
the (C) sites are occupied by a trivalent metal ion or a mixture of trivalent metal ions selected from the group consisting of: yttrium ions, scandium ions, lutetium ions, lanthanum ions, cerium ions, praseodymium ions, neodymium ions, promethium ions, samarium ions, europium ions, gadolinium ions, terbium ions, dysprosium ions, holmium ions, erbium ions, thulium ions, ytterbium ions; and
the (A) sites and the (D) sites are independently occupied by a trivalent metal ion or a mixture of trivalent metal ions selected from the group consisting of: aluminum ions, gallium ions, iron ions, chromium ions, and scandium ions.

22. The method of claim 19, wherein:
the garnet structure comprises (C) sites, (A) sites, and (D) sites;
the (C) sites are occupied by yttrium ions; and
the (A) sites and the (D) sites are independently occupied by a metal ion or a mixture of metal ions selected from the group consisting of: aluminum ions, iron ions, gallium ions, and scandium ions.

23. The method of claim 19, wherein:
the garnet structure comprises (C) sites, (A) sites, and (D) sites;
the (C) sites are occupied by a metal ion or a mixture of metal ions selected from the group consisting of: yttrium ions, cerium atoms, neodymium atoms, terbium atoms, ytterbium atoms; and
the (A) sites and the (D) sites are occupied by aluminum ions.

24. The method of claim 19, wherein the garnet structure comprises a yttrium-aluminum garnet (Y₃Al₅O₁₂).

25. The method of claim 19, wherein the coating further comprises one or more second cracks extending partially through the coating.

26. The method of claim 19, wherein the one or more second cracks extend at least half of the thickness of the coating.

27. The method of claim 19, wherein a first crack changes direction in extending completely through the coating.

28. The method of claim 19, wherein a plurality of first cracks change direction in extending completely through the coating.

29. The method of claim 19, wherein a first crack changes direction and changes width in extending completely through the coating.

30. The method of claim 19, wherein a plurality of first cracks change direction and change width in extending completely through the coating.

31. The method of claim 19, wherein a first crack changes width in extending completely through the coating.

32. The method of claim 19, wherein a plurality of first cracks change width in extending completely through the coating.

33. The method of claim 19, wherein the coating further comprises a plurality of yttrium-aluminum columns.

34. The method of claim 33, wherein the plurality of yttrium-aluminum columns are mechanically separated by the one or more first cracks.

35. The method of claim 19, wherein the coating further comprises inter-pass boundaries and splats including an average diameter that is less than or equal to 5 micrometers.

36. The method of claim 19, wherein the coating comprises a thermal barrier coating, and the thermal barrier coating includes a porosity in the range of ten volume percent to forty volume percent.

37. The method of claim 36, wherein:
the one or more first cracks each include a width in the range of 0.1 micrometers to 5.0 micrometers; and
the thickness of the thermal barrier coating is in the range of 50 micrometers to 5,000 micrometers.

38. The method of claim 19, wherein the coating comprises a thermal barrier coating.
